(19) United States
(12) Patent Application Publication
(10) Pub. No.: US 2022/0051207 A1
(43) Pub. Date: Feb. 17, 2022

(54) MULTICHANNEL RESOURCE CENTRALIZATION HUB WITH SELECTABILITY INTERFACE

(71) Applicant: BANK OF AMERICA CORPORATION, Charlotte, NC (US)

(72) Inventors: Christopher Nicholas King, Charlotte, NC (US); Lauren Marie Bavis, Cornelius, NC (US); Lisa D. Curry, Warwick, RI (US); James Eugene Illing, Charlotte, NC (US); Erin McCullen, Charlotte, NC (US); Anthony Charles Tremble, Charlotte, NC (US)

(73) Assignee: BANK OF AMERICA CORPORATION, Charlotte, NC (US)

(21) Appl. No.: 16/995,165

(22) Filed: Aug. 17, 2020

(51) Int. Cl. G06Q 20/10; G06Q 10/06; G06Q 20/02

(52) U.S. Cl. CPC G06Q 20/108; G06Q 20/027; G06Q 10/0631

(57) ABSTRACT

Embodiments of the invention are directed to a system, method, or computer program product for a multichannel resource centralization hub with a selectability interface. The invention extracts and coordinates account data across entities, such as a financial institution, for a user. The invention creates a single operating hub for user access and manipulation. In this way, the user may access a single interface for visualization of one operating account for the user. The operating hub allows a user to have multiple purpose resource envelopes within a single framework. As such, the user can have various separate sections within the operating hub for different actionable events. The system may allow for locking of resource envelopes, opening of envelopes for third parties, and threshold development of each individual envelope.

### BACKGROUND

With advancements in machine and product development, more and more machines and products are being implemented by businesses and used by individuals. With the advent of more and more machines and products, users have access to more options for their resource distribution needs.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention are directed towards a multichannel resource centralization hub with a selectability interface. The invention extracts and coordinates account data across an entity, such as a financial institution, for a user. The invention creates a single operating hub for user access and manipulation. In this way, the user may access a single interface for visualization of one operating account for the user. The operating hub allows a user to have multiple purpose accounts or access points within a single framework. As such, the user can have various separate sections within the operating hub for different savings goals, resource distributions, or the like. The system may provide a smart deposit and smart withdraw processing to ensure each separate section has an appropriate amount of resources available based on time.

Embodiments of the invention are directed to a system, method, and computer program product for a multichannel resource operation hub with selectability interface, the invention comprising: identifying and extracting user resource distribution accounts; generating a user specific operation hub comprising the user resource distribution accounts; generating resource envelopes within the user specific operation hub and allocate resources into the resource envelopes; setting rules for resource envelopes including threshold allocations and locking of resources within the resource envelopes; identifying a resource transfer request and match the resource transfer request to resources within a specific resource envelope; triggering resource transfer request denial and a user notification of the denial upon identification that the resource transfer request is matched to a specific resource envelope that is locked; and confirming and processing resource transfer request upon user confirmation.

In some embodiments, generating resource envelopes within the user specific operation hub and allocate resources into the resource envelopes further comprises allowing user generation of envelopes and system generation of envelopes for event savings, balance projection, and reoccurring resource distribution requirements.

In some embodiments, the user specific operation hub comprising the user resource distribution accounts further comprises a selectability interface allowing for visualization of a total resource amount across all user resource distribution accounts and a real-time status update of the total resource amount across all user resource distribution accounts.

In some embodiments, the resource envelopes comprise resources in a sub-location within the user specific operating hub, wherein the resources within the resource envelopes are designated for a specific product, event, or payment.

In some embodiments, the invention further comprises allowing third party access to one or more of the resource envelopes upon user approval, wherein third party access includes allowing for withdraw, deposit, and manipulation of resources within the one or more of the resource envelopes.

In some embodiments, the invention further comprises triggering resource transfer request denial and a user notification of the denial upon identification that the resource transfer request is matched to a specific resource envelope will be below a threshold resource amount after the resource transfer is processed.

In some embodiments, identifying and extracting user resource distribution accounts further comprises extracting user resource distribution accounts from third party financial institutions.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a multichannel operation hub with selectability interface system environment, in accordance with one embodiment of the present invention;

FIG. 2 provides a high level process for utilizing the multichannel operation hub, in accordance with one embodiment of the present invention;

FIG. 3 provides a high level process map illustrating enrollment in and initial processing of a user within the multichannel operation hub, in accordance with one embodiment of the present invention;

FIG. 4 provides a high level process flow illustrating interactions with the multichannel operation hub and selectability interface, in accordance with one embodiment of the present invention; and

FIG. 5 provides a high level process flow illustrating resource envelope locking within the multichannel operation hub and selectability interface, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to any entity or individual associated with a business. In some embodiments, the user may be the business. In some embodiments, the user may be an individual associated with the business. In some embodiments, identities of an individual may include online handles, usernames, aliases, family names, maiden names, nicknames, or the like. Furthermore, as used herein the term “user device” or “mobile device” may refer to mobile phones, personal computing devices, tablet computers, wearable devices, and/or any portable electronic device capable of receiving and/or storing data therein associated with the business.

As used herein, a “user interface” generally includes a plurality of interface devices and/or software that allow a user to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

A “transaction” or “resource distribution” refers to any communication between a user and the financial institution or other entity monitoring the user's activities to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

Embodiments of the invention are directed to a system, method, or computer program product for a multichannel resource centralization hub with a selectability interface. The invention extracts and coordinates account data across entities, such as a financial institution, for a user. The invention creates a single operating hub for user access and manipulation. In this way, the user may access a single interface for visualization of one operating account for the user. The operating hub allows a user to have multiple purpose resource envelopes within a single framework. As such, the user can have various separate sections within the operating hub for different actionable events. The system may allow for locking of resource envelopes, opening of envelopes for third parties, and threshold development of each individual envelope.

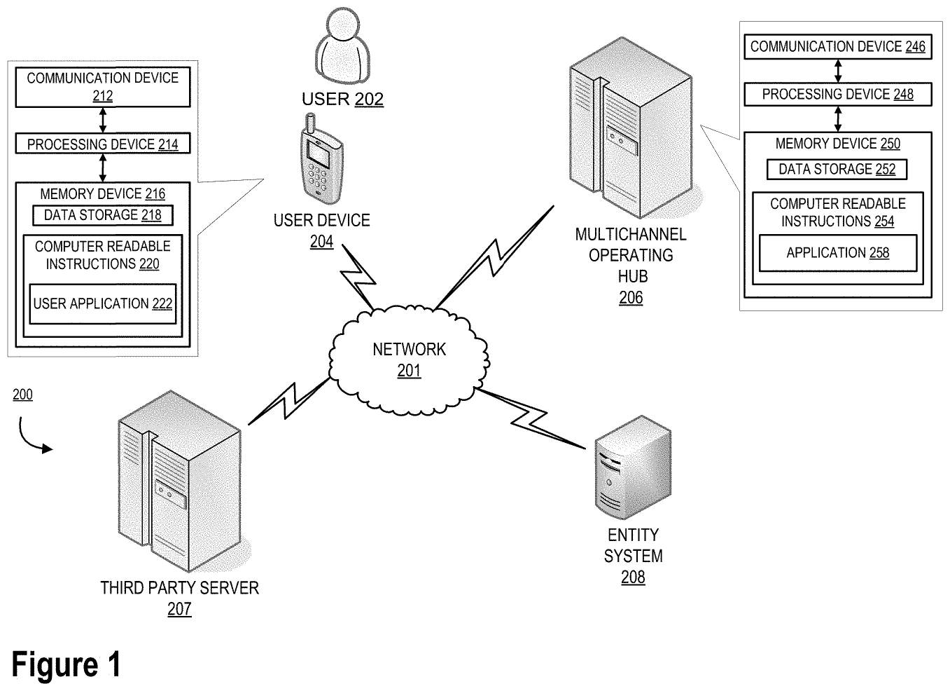

FIG. 1 illustrates a multichannel operation hub with selectability interface system environment system environment 200, in accordance with one embodiment of the present invention. FIG. 1 provides the system environment 200 for which the distributive network system with specialized data feeds associated with resource distribution. FIG. 1 provides a unique system that includes specialized servers and system communicably linked across a distributive network of nodes required to perform the functions of digital onboarding across platforms, intelligent search engine text modification, and real-time resource distribution and cross channel application processing.

As illustrated in FIG. 1, the entity system 208 is operatively coupled, via a network 201 to the user device 204, third party servers 207, and to the multichannel operating hub 206. In this way, the entity system 208 can send information to and receive information from the user device 204, third party servers 207, and the multichannel operating hub 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual that has one or more user devices 204, one or more accounts, and is in communication with an entity. A user, as described herein may be an individual or business interacting with the system, such as an individual with an account maintained by the entity associated with the system. In this way, a user can communicate with an entity via one of various communication channels, such as in person, on the phone, over the internet, text, or the like. The user may be a current customer of the entity or may be a new customer of the entity. The user may be being enrolled in a product or service provided by the entity. In some embodiments, the user 202 has a user device, such as a mobile phone, tablet, computer, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the multichannel operating hub 206, the entity system 208, and the third party sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the multichannel operating hub 206.

As further illustrated in FIG. 1, the multichannel operating hub 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the entity system 208, the third party server 207, and the user device 204. As such, the communication device 246 generally comprises a modem, server, or other device for communicating with other devices on the network 201.

As further illustrated in FIG. 1, the multichannel operating hub 206 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the multichannel operating hub 206 the memory device 250 stores an application 258. In one embodiment of the invention, the application 258 may associate with applications having computer-executable program code that generate and code a tag for implementation onto a product. Furthermore, the multichannel operating hub 206, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more entity system 208, third party servers 207, and/or user device 204.

In the embodiment illustrated in FIG. 1 and described throughout much of this specification, the application 258 may generate and display a dashboard on the user device 204 via a communication channel through the network 201. The communication channel may be closed and secure, such that the application 258 may present sensitive user or business information about resources and the like to the user device 204.

As illustrated in FIG. 1, the third party server 207 is connected to the entity system 208, user device 204, and multichannel operating hub 206. The third party server 207 has the same or similar components as described above with respect to the user device 204 and the multichannel operating hub 206. While only one third party server 207 is illustrated in FIG. 1, it is understood that multiple third party servers 207 may make up the system environment 200. The third party server 207 may be associated with one or more third party entities, third party financial institutions, or the like.

As illustrated in FIG. 1, the entity system 208 is connected to the third party server 207, user device 204, and multichannel operating hub 206. The entity system 208 may be associated with the multichannel operating hub 206 providing entity. In this way, the entity system may be a financial institution entity system or the like. The entity system 208 has the same or similar components as described above with respect to the user device 204 and the multichannel operating hub 206. While only one entity system 208 is illustrated in FIG. 1, it is understood that multiple entity system 208 may make up the system environment 200. It is understood that the servers, systems, and devices described herein illustrate one embodiment of the invention. It is further understood that one or more of the servers, systems, and devices can be combined in other embodiments and still function in the same or similar way as the embodiments described herein. The entity system 208 may generally include a processing device communicably coupled to devices as a memory device, output devices, input devices, a network interface, a power source, one or more chips, and the like. The entity system 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the entity system 208 described herein.

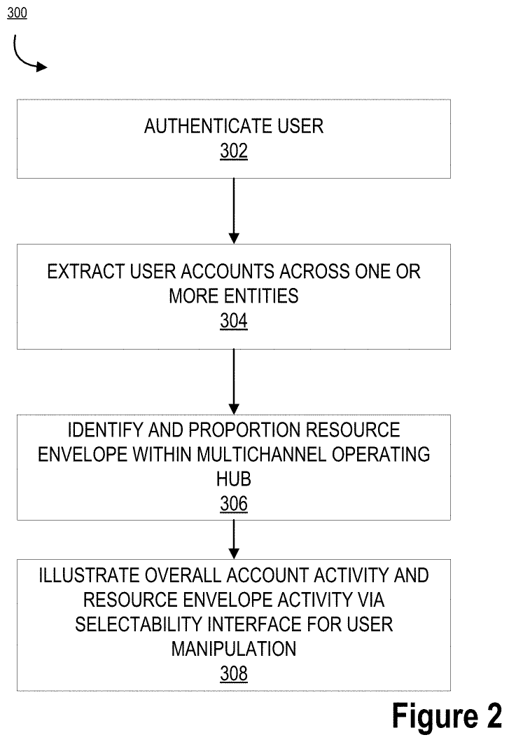

FIG. 2 provides a high level process for utilizing the multichannel operation hub 300, in accordance with one embodiment of the present invention. As illustrated in block 302, the process 300 is initiated by an entity authenticating a user during the user enrollment process. Authentication of a user can occur via the user answering security questions, fingerprint authentication, or the like. In this way, a user can communicate with an entity via one of various communication channels, such as in person, on the phone, over the internet, text, or the like. The user may be a current user of the entity or may be a new user of the entity. The user may be being enrolled in a product or service provided by the entity.

As illustrated in block 304, the process 300 continues by extracting user accounts across one or more entities to include into the multichannel operating hub for user visualization. These accounts may include deposit accounts, resource storage accounts, money market accounts, rewards accounts, loan accounts, or any other account that may be associated with resource storage or distribution of resources or auxiliary resources. After extraction, the user may be able to add additional accounts or remove accounts from being included into the multichannel operating hub.

Next, as illustrated in block 306, the process 300 continues by identifying and proportion resource envelopes within the multichannel operation hub for the user. In this way, the system may be able to generate resource envelopes, the user may be able to generate resource envelopes, or the like. There may be envelopes for user resource savings goals, user event goals, balance projection envelopes, expense envelopes, or the like. The goals may include a minimum savings amount, maximum savings amount. Furthermore, the system ay provide feedback to the user regarding the progress of the goal achievement and the like. Therefore the system provides a feedback loop for the user. The system may be able to allocate resources to the resource envelopes for the user based on user preferences, user selection, historic resource distribution, or artificial intelligent learning technology learning the trends and actions of the user to predict the resource allocation.

Finally, as illustrated in block 308, the process 300 is finalized by illustrating the overall account activity and each individual resource envelope activity via a selectability interface. This allows for user manipulation of resources across resource envelopes and for a overall view of the users resources across multiple accounts.

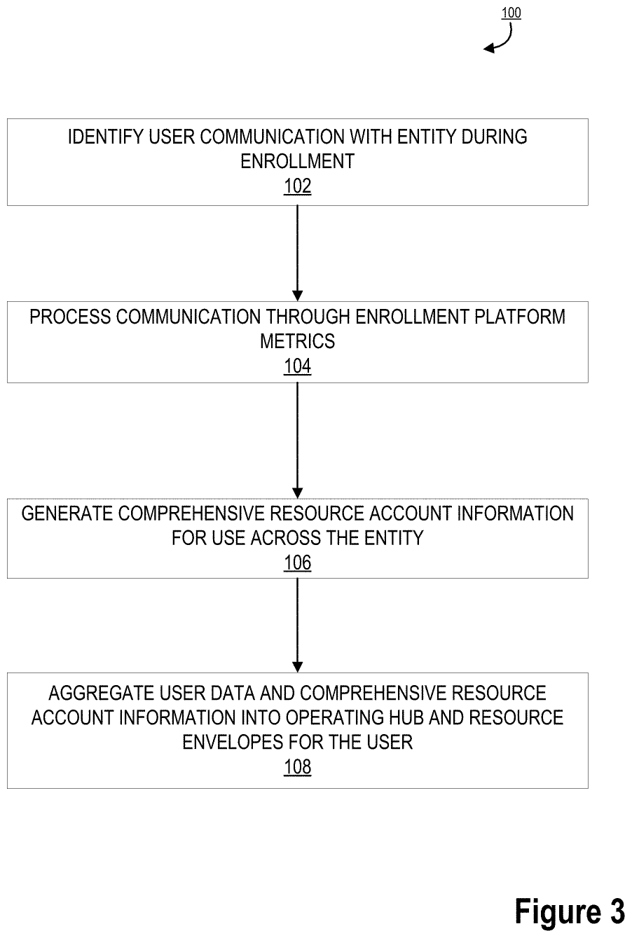

FIG. 3 provides a high level process map illustrating enrollment in and initial processing of a user within the multichannel operation hub 100, in accordance with one embodiment of the present invention. As illustrated in block 102, the process 100 is initiated by identifying user communications with an entity during enrollment. Using this data the system may process communications through enrollment platform metrics, as illustrated in block 104. This may provide an indication of the resource envelopes the user may have or desire, the accounts that the user may have that need to be extracted and incorporated into the operating hub, or the like. Furthermore, as illustrated in block 106, the process 100 may continue to use the user data gathered at enrollment to generate a comprehensive list of resource account information for the user across the entity and across third party entities. The system may extract these accounts into the operating hub for user visualization within the single access point.

Finally, as illustrated in block 108, the set up process 100 is finalized by aggregating the user data and comprehensive resource account information into the operating hub and generating resource envelopes for the user to store resources within a single account within the operating hub. In this way, the system may store all of the user accounts within a single operating account or operating hub. This provides the user with visualization of all of his/her resources within a single location. Furthermore, the system allows for all of the various accounts to be manipulated from the hub. As such, resources may be distributed, accepted, processed, or otherwise manipulate the resources from all the various accounts in a single location. Furthermore, the system may process the resources from the various accounts and parse the resources into one or more resource envelopes. These envelopes may act as sub-accounts or sub-compartments for resource storage for specific items within the operating hub or operating account. These specific items may include storage for resource savings goals, balance projections, upcoming expense savings, and the like.

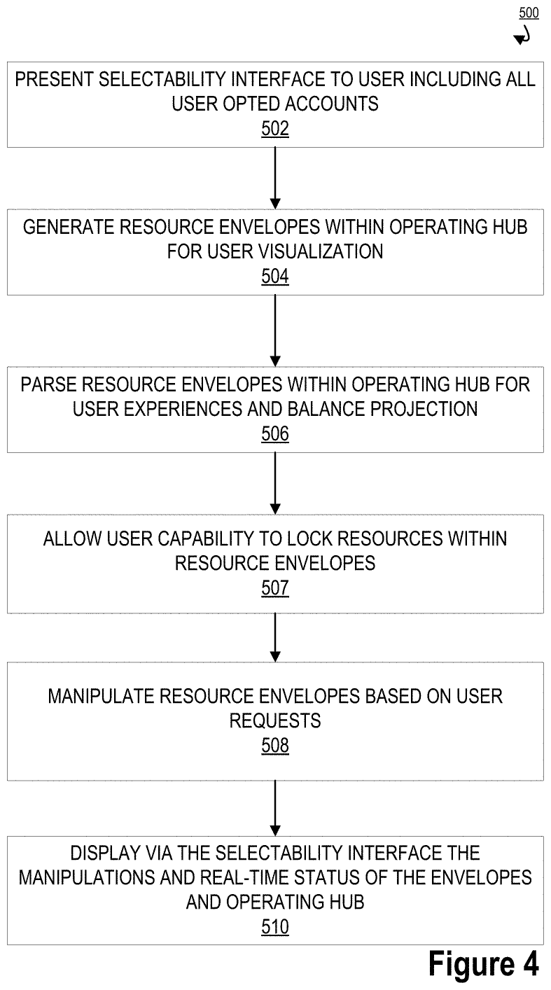

FIG. 4 provides a high level process flow illustrating interactions with the multichannel operation hub and selectability interface 500, in accordance with one embodiment of the present invention. As illustrated in block 502, the process 500 is initiated by presenting a selectability interface to the user for visualization of all of the user accounts selected and stored within the operating hub. In this way, these accounts may be from multiple financial institutions and be multiple different types of accounts. The operating hub may store all of these accounts in a single location for user visualization via the selectability interface.

As illustrated in block 504, the process 500 continues by generating one or more resource envelopes within the operating hub for user visualization. The user may generate a resource envelope or the system may generate a resource envelope. The resource envelope may have a goal amount of resources to be stored within the envelope or a threshold amount that must be maintained within the envelope. Each envelope may be designated for a specific goal, a specific reoccurring expense, or the like. As illustrated in block 506, the resource envelopes are parsed within the operating hub for user experiences, goals, reoccurring expenses, balance projections, and the like. As such, an amount of resources from the multiple accounts may be placed into one or more envelopes. These envelopes may have a threshold amount that it cannot go under, a goal amount of resources, or the like.

As illustrated in block 507, the process 500 continues by further allowing the user to lock resources within the resource envelopes. As such, if a user is attempting to perform a resource distribution with resources from the resource envelope, the system may deny the distribution if the amount of resources in the envelope will be below a threshold after the distribution. As illustrated in block 508, the process 500 continues by allowing for continued and varied manipulation of the resource envelopes by the user, by the system based on predictive artificial intelligent applications or the like. Furthermore, the system allows the user to authorize multiple other individuals to access, withdraw, or deposit resources within individual envelopes within the user's operating hub. Along with access, the user may be able to transfer envelopes to and from one or more other individuals, wherein transferring the envelope allows for transferring of the resources within the envelope. Furthermore, the system may allow for transparence for the user and approved individuals into the envelopes that are approved for the individuals. Furthermore, the system may be able to set parental controls, user controls, spending controls, and the like for each of the envelopes.

Finally, as illustrated in block 510, the process 500 is finalized by displaying via the selectability interface any of the manipulations to the envelopes, the real-time status of the envelopes and the resources within each one, and the overall resources in the operating hub associated with the user.

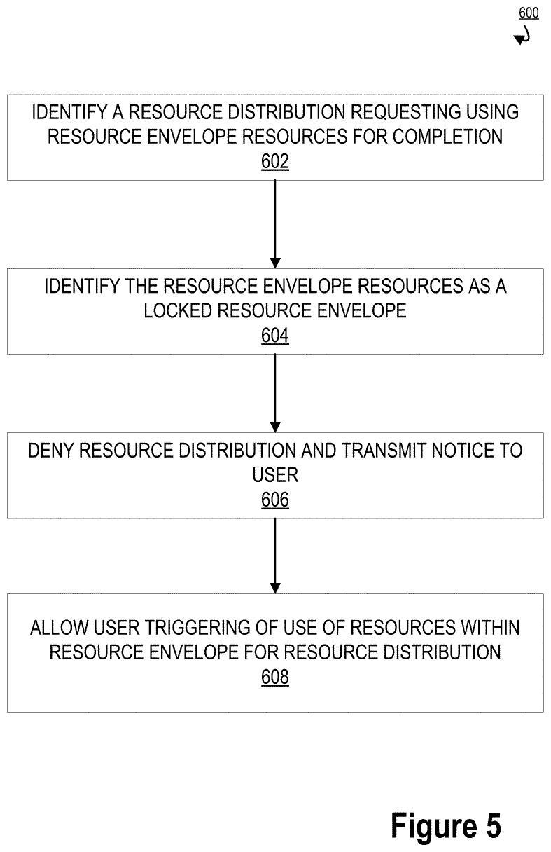

FIG. 5 provides a high level process flow illustrating resource envelope locking within the multichannel operation hub and selectability interface 600, in accordance with one embodiment of the present invention. As illustrated in block 602, the process 600 is initiated by identifying a resource distribution request using resource envelope resources for completion of the request. In this way, a user may be transacting with a merchant. The transaction being a part of one or more of the envelopes the user has, such as “entertainment budget envelope”, “food budget envelope”, “reoccurring payment envelope”, “goal envelope”, or the like. The system may identify the transaction as being a transaction that matches one or more of the user's envelopes and the system may extract resources from that envelope to complete the transaction. The system may extract these resources irrespective of the payment method used by the user, since the hub houses all or most of the user resource accounts. As such, the hub is notified of the transaction and utilizes resources based on the envelope not based on the payment account used for the transaction.

Next, as illustrated in block 604, the process 600 continues by identifying that the resource envelope resources associated with the transaction are either locked or will be below the envelope threshold after completion of the transaction. As such, the system may double check and confirm the transaction is for a product or service within the envelope.

If the transaction is requiring resources within the envelope and the envelope is locked or will be under a threshold amount, the system may perform an initial deny the resource distribution and transmit a notice to the user via the user device, as illustrated in block 606. The notice may be transmitted to the user device and notify the user that the transaction will violate a rule associated with the envelope, such as the threshold or that it is a locked envelope. As illustrated in block 608, part of the notification may allow or confirm the user to override the rule and to allow for the user confirmation and use of the resources within the resource envelope for the resource distribution.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for a multichannel resource operation hub with selectability interface, the system comprising:
a memory device with computer-readable program code stored thereon;
a communication device, wherein the communication device is configured to establish operative communication with a plurality of networked devices via a communication network;
a resource interaction processing device operatively coupled to the memory device, and the communication device, wherein the processing device is configured to execute the computer-readable program code to:
identify and extract user resource distribution accounts;
generate a user specific operation hub comprising the user resource distribution accounts;
generate resource envelopes within the user specific operation hub and allocate resources into the resource envelopes;
set rules for resource envelopes including threshold allocations and locking of resources within the resource envelopes;
identify a resource transfer request and match the resource transfer request to resources within a specific resource envelope;
trigger resource transfer request denial and a user notification of the denial upon identification that the resource transfer request is matched to a specific resource envelope that is locked; and
confirm and process resource transfer request upon user confirmation.

2. The system of claim 1, wherein generating resource envelopes within the user specific operation hub and allocate resources into the resource envelopes further comprises allowing user generation of envelopes and system generation of envelopes for event savings, balance projection, and reoccurring resource distribution requirements.

3. The system of claim 1, wherein the user specific operation hub comprising the user resource distribution accounts further comprises a selectability interface allowing for visualization of a total resource amount across all user resource distribution accounts and a real-time status update of the total resource amount across all user resource distribution accounts.

4. The system of claim 1, wherein the resource envelopes comprise resources in a sub-location within the user specific operating hub, wherein the resources within the resource envelopes are designated for a specific product, event, or payment.

5. The system of claim 1, further comprising allowing third party access to one or more of the resource envelopes upon user approval, wherein third party access includes allowing for withdraw, deposit, and manipulation of resources within the one or more of the resource envelopes.

6. The system of claim 1, further comprising triggering resource transfer request denial and a user notification of the denial upon identification that the resource transfer request is matched to a specific resource envelope will be below a threshold resource amount after the resource transfer is processed.

7. The system of claim 1, wherein identifying and extracting user resource distribution accounts further comprises extracting user resource distribution accounts from third party financial institutions.

8. A computer program product for a multichannel resource operation hub with selectability interface, the computer program product comprising at least one non-transitory computer-readable medium having computer-readable program code portions embodied therein, the computer-readable program code portions comprising:
an executable portion configured for identifying and extracting user resource distribution accounts;
an executable portion configured for generating a user specific operation hub comprising the user resource distribution accounts;
an executable portion configured for generating resource envelopes within the user specific operation hub and allocate resources into the resource envelopes;
an executable portion configured for setting rules for resource envelopes including threshold allocations and locking of resources within the resource envelopes;
an executable portion configured for identifying a resource transfer request and match the resource transfer request to resources within a specific resource envelope;
an executable portion configured for triggering resource transfer request denial and a user notification of the denial upon identification that the resource transfer request is matched to a specific resource envelope that is locked; and
an executable portion configured for confirming and processing resource transfer request upon user confirmation.

9. The computer program product of claim 8, wherein generating resource envelopes within the user specific operation hub and allocate resources into the resource envelopes further comprises allowing user generation of envelopes and system generation of envelopes for event savings, balance projection, and reoccurring resource distribution requirements.

10. The computer program product of claim 8, wherein the user specific operation hub comprising the user resource distribution accounts further comprises a selectability interface allowing for visualization of a total resource amount across all user resource distribution accounts and a real-time status update of the total resource amount across all user resource distribution accounts.

11. The computer program product of claim 8, wherein the resource envelopes comprise resources in a sub-location within the user specific operating hub, wherein the resources within the resource envelopes are designated for a specific product, event, or payment.

12. The computer program product of claim 8, further comprising an executable portion configured for allowing third party access to one or more of the resource envelopes upon user approval, wherein third party access includes allowing for withdraw, deposit, and manipulation of resources within the one or more of the resource envelopes.

13. The computer program product of claim 8, further comprising an executable portion configured for triggering resource transfer request denial and a user notification of the denial upon identification that the resource transfer request is matched to a specific resource envelope will be below a threshold resource amount after the resource transfer is processed.

14. The computer program product of claim 8, wherein identifying and extracting user resource distribution accounts further comprises extracting user resource distribution accounts from third party financial institutions.

15. A computer-implemented method for a multichannel resource operation hub with selectability interface, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying and extracting user resource distribution accounts;
generating a user specific operation hub comprising the user resource distribution accounts;
generating resource envelopes within the user specific operation hub and allocate resources into the resource envelopes;
setting rules for resource envelopes including threshold allocations and locking of resources within the resource envelopes;
identifying a resource transfer request and match the resource transfer request to resources within a specific resource envelope;
triggering resource transfer request denial and a user notification of the denial upon identification that the resource transfer request is matched to a specific resource envelope that is locked; and
confirming and processing resource transfer request upon user confirmation.

16. The computer-implemented method of claim 15, wherein generating resource envelopes within the user specific operation hub and allocate resources into the resource envelopes further comprises allowing user generation of envelopes and system generation of envelopes for event savings, balance projection, and reoccurring resource distribution requirements.

17. The computer-implemented method of claim 15, wherein the user specific operation hub comprising the user resource distribution accounts further comprises a selectability interface allowing for visualization of a total resource amount across all user resource distribution accounts and a real-time status update of the total resource amount across all user resource distribution accounts.

18. The computer-implemented method of claim 15, wherein the resource envelopes comprise resources in a sub-location within the user specific operating hub, wherein the resources within the resource envelopes are designated for a specific product, event, or payment.

19. The computer-implemented method of claim 15, further comprising allowing third party access to one or more of the resource envelopes upon user approval, wherein third party access includes allowing for withdraw, deposit, and manipulation of resources within the one or more of the resource envelopes.

20. The computer-implemented method of claim 15, further comprising triggering resource transfer request denial and a user notification of the denial upon identification that the resource transfer request is matched to a specific resource envelope will be below a threshold resource amount after the resource transfer is processed.
